(19) United States
(12) Patent Application Publication
(10) Pub. No.: US 2009/0245074 A1
(43) Pub. Date: Oct. 1, 2009

(54) PICK-UP HEAD ASSEMBLY FOR OPTICAL DISC EMPLOYING ELECTRICALLY TUNABLE LIQUID CRYSTAL LENS

(75) Inventor: Ling-Yuan Tseng, Saratoga, CA (US)

Correspondence Address: GIFFORD, KRASS, SPRINKLE,ANDERSON & CITKOWSKI, P.C, PO BOX 7021, TROY, MI, 48007-7021, US

(73) Assignee: TUNABLE OPTIX CORPORATION, Hsinchu (TW)

(21) Appl. No.: 12/416,334

(22) Filed: Apr. 1, 2009

Related U.S. Application Data
(60) Provisional application No. 61/041,393, filed on Apr. 1, 2008.

(51) Int. Cl. G11B 7/135

(52) U.S. Cl. 369/112.24; G9B/7.112

(57) ABSTRACT

An optical disc storage system employs a read/write pick-up head assembly in which the optical path between the disc and the read/write light source, usually a laser diode, includes both a conventional objective lens formed of glass or plastic, with a fixed focus, and a liquid crystal lens which is electrically tunable to vary its refractive index and focal distance. The optical signal reflected from the disc is passed through this hybrid pick-up head assembly and demodulated to detect errors in the focus of the pick-up head and the tracking, and to adjust the focus by modifying the electrical signals applied to the LCD lens, and move the pick-up head in the plane of the disc to address the appropriate track.

### CROSS-REFERENCE TO RELATED APPLICATIONS

This application claims priority of U.S. Provisional Patent Application Ser. No. 61/041,393 filed Apr. 1, 2008, which is incorporated herein by reference.

### FIELD OF THE INVENTION

This invention relates to optical memories and more particularly to read and/or write pick-up head assemblies employing combinations of conventional objective lenses in series with electrically tunable liquid crystal lenses for purposes of focus and track correction.

### BACKGROUND OF THE INVENTION

The technique of using a laser beam to read data recorded on an optical medium such as a CD, DVD or Blu-ray disc is well known in the art. The laser beam is focused on the track on the surface of the optical disc through an objective lens located in an optical pick-up head, and a photodetector is then used to transform the light reflected from the optical disc to regenerated signals so that the data recorded on the optical disc may be retrieved. During the data reading process, a tracking signal, focusing signal and the like have to be retrieved from the reflected light. The tracking signal and the focusing signal are used to control an actuator to move the objective lens toward and away from the disc, in a focusing direction. By way of example, U.S. Pat. No. 6,839,307 discloses a servo system of this type.

The movement of the pick-up head toward and away from the disc, during readout, inherently requires some time and the mechanical movement of the actuator of the pick-up head will degrade the system reliability of the optical disc.

### SUMMARY OF THE INVENTION

Accordingly, the present invention is directed toward a system wherein the need for motion of the pick-up head toward and away from the disc in order to maintain appropriate focus and tracking, and the necessary actuator to produce this motion, are eliminated, and an essentially solid state pick-up head is produced. This pick-up head is inherently capable of more accurate focusing and tracking because of the elimination of the time required for motion of the pick-up head. Moreover, the elimination of motion eliminates the wear which inherently degrades the system reliability over time.

Broadly, the system of the present invention employs the combination of a fixed focus objective lens combined with an electrically tunable liquid crystal lens. The structure, and possibly the refractive index of the liquid crystal, will be varied as a function of the voltage applied, which may be derived by processing the reflected signal to detect focus and tracking errors, with these signals used to feed the LC lens in the same way as the servo signal mechanically drives the lens toward and away from the disc in prior art systems. The liquid crystal lens may be of any of a variety of known types, including lenses in which the applied voltage physically shapes the lens, systems in which a plurality of liquid crystal droplets form the lens and the lens may be tuned by applying voltage to the droplets, as well as others.

In one embodiment of the invention, which will be subsequently described in detail, the axis of the laser beam between the pick-up head and the disc can be varied by applying different voltages to different segments in the same electrode layer of the liquid crystal lens.

The liquid crystal lens structure could employ a single LC layer, or double LC layers, with orthogonal orientation to each other.

### BRIEF DESCRIPTION OF THE DRAWINGS

Other advantages, applications and objects of the present invention will be made apparent by the following detailed description of preferred embodiments of the invention. The description makes reference to the accompanying drawings in which:

FIG. 1 is a diagram illustrating the hybrid objective lens of the present invention consisting of a conventional fixed focus objective lens which passes laser light through an electrically tunable LC lens;

FIG. 2 is a block diagram showing the structure of an optical disc pick-up head assembly formed in accordance with the present invention in operating relationship to an optical disc;

FIG. 3 is a schematic diagram of a typical electrically tunable LC lens structure;

FIG. 4 is a schematic diagram of an alternative form of electrically tunable LC lens with a circular void in the center of the ITO layer;

FIG. 5 is a perspective view of the ITO layers employed in the electrically tunable LC lens of FIG. 4;

FIG. 6 is a schematic diagram from a perspective view of another form of electrically tunable LC lens, illustrating only the ITO layers, with the upper ITO layer employing a central point electrode;

FIG. 7 is a schematic diagram of another electrically tunable lens ITO layer employing a plurality of segments which allows the axis of the laser beam to be shifted;

FIG. 8 is a schematic side view of an electrically tunable, axially steerable LC lens employing a center point ITO layer with a plurality of segments which may be used to steer the beam;

FIG. 9 is a schematic diagram showing the movement of an optical disc pick-up assembly relative to a disc; and

FIG. 10 is a schematic diagram of the various components of the pick-up head assembly and reflected beam processing elements to control a hybrid LC lens pick-up, all shown relative to a disc.

### DETAILED DESCRIPTION OF THE INVENTION

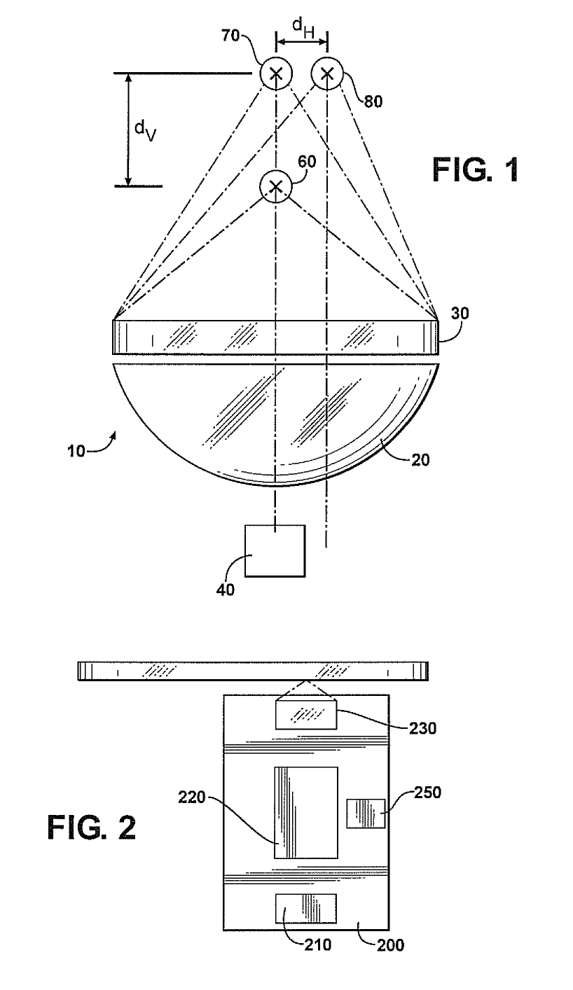

Referring to FIG. 1, which illustrates a basic structure of the hybrid objective lens module, generally indicated at 10, in schematic form, the hybrid module simply comprises the combination of a conventional, fixed focus convex lens 20 and an electrically tunable LC lens 30 disposed in the beam outputted by a laser light source 40 to interrogate an optical disc (not shown). The fixed focus lens 20 serves as the objective to focus the light from the laser source 40 onto the disc. The lens could be either spherical or aspherical and made of glass or plastic. The lens structure could be in the form of a fixed single focal length lens, or a multiple lens structure with more than one lens surface curvature.

After passing through the conventional lens 20, the beam from the source 40 passes through an electrically tunable LC lens 30. The LC lens 30 may take any known form such as that shown in U.S. Pat. Nos. 4,572,616; 6,545,739; etc. Broadly, as described in more detail in connection with the subsequent figures, it consists of a liquid crystal layer disposed between a pair of electrodes so that the electric field experienced by the lens may be adjusted to produce changes in the focal length of the hybrid lens 10.

The focal length of the hybrid lens 10 is thus influenced by both the focal length of the conventional lens 20 and the current focal length of the LC lens 30. In FIG. 1, 60 indicates a particular focal length of the hybrid lens 10. By modifying the voltage applied to the LC lens 30, the focal point may be moved in the axial distance, for example to the focal point 70. With one of the LC lenses having segmented electrodes, such as illustrated and described in connection with FIG. 7, the focal point may be moved transverse to the axial dimension, for example to point 80 in FIG. 1. FIG. 1 illustrates the shift in the axial direction as D_{V} and the shift in the transverse direction as D_{H}.

FIG. 2 illustrates a block diagram of the structure of an optical disc pick-up assembly 200, employing a hybrid lens structure of the type illustrated in FIG. 1.

The assembly includes a light transmission module 210 which is preferably a laser diode. The wavelength of the laser diode 210 depends upon the type of optical disc 240 loaded into the system. For example a 780 nm laser diode is required for CDs, a 650 nm light source for DVDs and a 405 nm light source for Blu-ray discs (BD). In order to create an optical disc player that may play all of the available varieties of optical discs, a plurality of different laser diode sources may be provided. Other conventional optical components associated with the laser diode such as a collimating lens, diffraction gratings, a dichroic mirror and others will typically be provided in the light transmission module 210.

The light beam from the light transmission module 210 is directed at a light path handling module 220. This module performs the wavelength purification, light beam splitting for transmission and receiving, retarding plate and other well known functions. The light from the unit 220 is passed to the objective lens module 230 of the type generally indicated at 10 in FIG. 1. Additionally, it usually contains a hologram diffraction filter to accommodate the different wavelengths with matching numerical aperture (NA) and focal depth for different reflection distances. For example, the NA value for a CD—0.45, DVD—0.60 and BD—0.85. The NA is defined by D/2f where D is the active diameter of the objective lens and f is the focal length of the objective lens. The reflection thicknesses for the different discs are CD—1.2 mm, DVD—0.6 mm and BD—0.1 mm. The light reflected from the optical disc 240 is captured by the light receiving module 250 which is a part of the pick-up head assembly 200. This module is operative to receive the modulated light and demodulate it and provide it to a data processing unit (not shown). The unit includes conventional elements such as an optical sensor detecting lens, cylindrical lenses, etc. In order to detect the reading error from the disc, there will be a plurality of sensing segments on the light sensor unit. By detecting the position of focus of the light, the error data can be processed and appropriate correction actions taken.

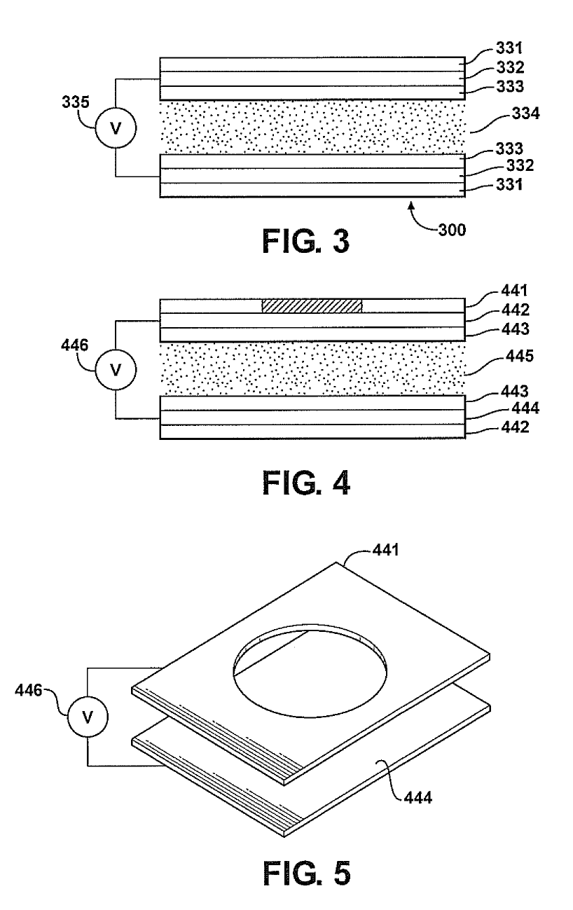

A typical LC lens structure 300 is schematically illustrated in FIG. 3. Layer 331 is usually transparent glass with a high transmission rate and solid in nature. 332 constitutes the electrode layer. It is transparent and indium-tin oxide is the material widely used because it is both electrically conductive and transparent. Element 333 is an alignment layer to assure that the LC modules of the LC core 334 are aligned in the desired orientation and direction. Typically it is formed of an organic material such as polyimide or nonorganic material such as SiO₂ or SiO_{X}. 335 is the power supply that creates a potential difference across the two layers 332 in each half and causes the liquid crystal material 334 to vary in optical properties as the voltage between the two electrodes is changed.

FIG. 4 is a diagram, similar to FIG. 3, illustrating a form of liquid crystal cell which has a central hole in the center of the ITO electrode layer 441. Layer 442 is the glass substrate, layer 443 the alignment layer, and 445 the liquid crystal layer. 446 provides the electric field across the two electrodes 441 and 444 in each half The central hollow ITO electrode layer may take any one of several forms such as those disclosed in U.S. Patent Application Publication 2007/0139333. The central hole in the ITO layer shapes the electric field applied to the LC layer 445 to produce an appropriate shape to the liquid crystal layer.

FIG. 5 is a perspective view of the two ITO electrode layers in the device of FIG. 4. When voltage is applied to the two ITO layers 441 and 444, the electric field created is stronger along the inner edge of the circular hole in the electrode 441 and weaker toward the center and will force the LC molecules to form an equivalent convex lens effect. As the voltages vary the focal length of this will be changed. The total focal length of this objective lens module will be, for the example shown in FIG. 1, 1/f(t)=1/f(c)+1/f(1) where f(t) is the total focal length, f(c) is the focal length provided by the fixed focal length of the conventional lens, and (f)1 is the focal length contributed by the LC lens, its focal length depending on the voltage applied.

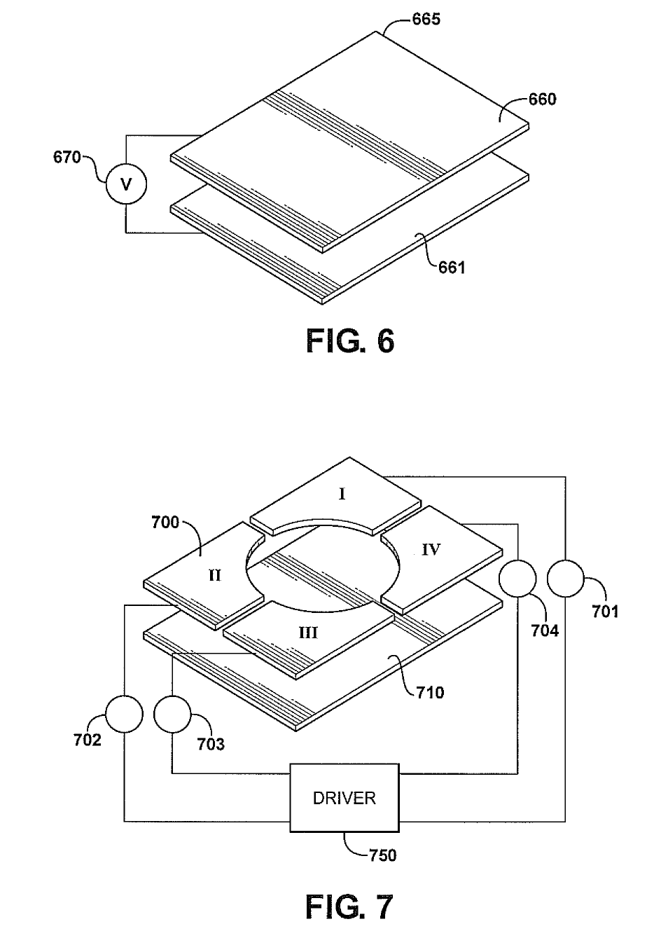

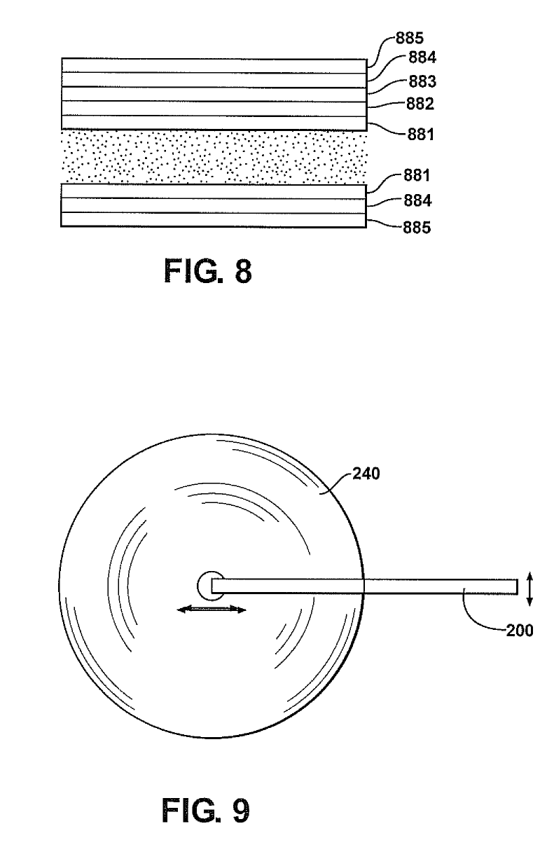

In some different designs the conventional objective lens could have multiple focal lengths and consist of more than one curvature surface as disclosed in U.S. Patent Application 60/942,310 or U.S. patent application Ser. No. 11/850,248. FIG. 6 discloses the two opposed ITO electrode layers of an LC lens wherein the upper layer 660 is powered by a central point electrode 665. The bottom plain ITO layer is denominated 661, and 670 is the power unit of the ITO segments. Again, this structure will force the LC molecules to form an equivalent lens effect.

FIG. 7 discloses the ITO upper and lower layers 700 and 710 of an LC lens module in which the upper ITO layer 700 is divided into four segments, I, II, III and IV. Each of the segments is connected to a driver unit 750 by connections 701, 702, 703 and 704 respectively. By selectively energizing one or a combination of the segments of the upper electrode 700, the laser beam may be optically steered in a direction transverse to the beam axis.

The center point ITO construction of the type shown in FIG. 6 can be combined with the plural segmented construction illustrated in FIG. 7 to achieve light axis movement. The basic structure of this electrode design is disclosed in U.S. Patent Application 60/033,050. It consists of an upper module with an alignment layer 881, an ITO layer 882 with a center point electrode, an insulation layer 883 consisting of a thin glass layer like SiO₂ or SiO_{X}, a plain ITO layer 884 formed on a substrate 885.

FIG. 9 is a diagram showing the movement of a disc pick-up head assembly 200 relative to an optical disc 240. The head is stationary in a plane transverse to the plane of the paper with the LC lens accommodating the necessary focus adjustment while an actuator must move the head 200 in a radial direction to locate the proper track.

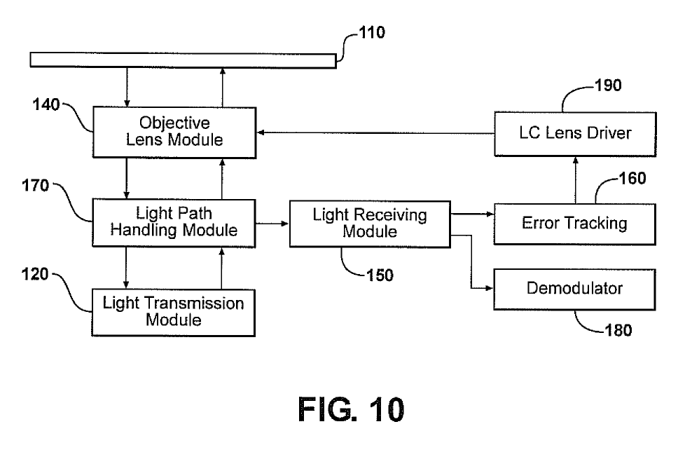

FIG. 10 illustrates the light path in the entire pick-up head assembly. In this schematic drawing, the optical disc 110 is interrogated with a laser beam derived from a light transmission module which is passed through a light path handling module 170 to an objective lens module 140. The reflected beam from the disc passes through the objective lens module in the reverse direction and then through the light path handling module. It is then passed to a light receiving module 150 and then to a demodulator 180 which derives the intelligence on the disc and passes it to appropriate utilization circuitry and to an error tracking module 160. This module performs a comparison algorithm on the reflected processed beam and derives an error message. The error message is compiled into a control signal and fed to a driver unit 170. There are many different error detecting algorithms and methods disclosed in the prior art patents. The driver unit will modify the voltage on the liquid crystal module contained within the objective lens module 140 and/or apply different voltages at different ITO segments if a segmented ITO layer is utilized.

Having thus described my invention I claim:

1. A read and/or write head for an optical memory disc, comprising:
a laser light source operative to generate a laser beam;
a light transmission module adapted to receive the laser beam, the light transmission module comprising a fixed focus convex objective lens and an electrically tunable liquid crystal lens arranged along the path of the laser beam; and
a light receiving module connected to receive light from the beam reflected from the optical memory disc and to generate drive signals for the liquid crystal lens to maintain the focal point of the laser beam on the required track of the optical disc.

2. A pick-up head for an optical memory disc, comprising:
a laser light source operative to generate a laser beam;
a light transmission module adapted to receive the laser beam, the light transmission module comprising a fixed focus objective lens and an electrically tunable liquid crystal lens arranged along the optical path of the laser beam; and
a light receiving module connected to receive light from the beam reflected from the optical memory disc and to generate driving signals for the liquid crystal lens to maintain the focal point of the laser beam on the required track of the optical disc.

3. The pick-up head for an optical memory disc of claim 2 wherein the electrically tunable liquid crystal lens comprising a liquid crystal element sandwiched between two planar electrodes and the driving signals for the liquid crystal lens is applied to the two electrodes.

4. The pick-up head for an optical memory disc of claim 3 wherein one of the planar electrodes has a central circular void.

5. The pick-up head for an optical memory disc of claim 3 wherein one of the planar electrodes is connected to receive driving signals via a connection to the center of the electrode.

6. The pick-up head for an optical memory disc of claim 3 wherein at least one of the planar electrodes has a plurality of segments electrically insulated from one another and the driving signal is moved between the segments to displace the laser beam in the direction normal to its axis to maintain the focal point of the laser beam on a required track of the optical disc.

7. The pick-up head for an optical memory disc of claim 6 wherein the non-segmented electrode sandwiching the liquid crystal element has a connection to the driving voltage at the center of the electrode.

8. The pick-up head for an optical memory disc of claim 3 wherein the electrodes are formed of indium-tin oxide.

9. The pick-up head for an optical memory disc of claim 8 wherein the indium-tin oxide electrode layers of the liquid crystal lens are each formed on a planar glass substrate and covered by a planar alignment layer.

10. The pick-up head for an optical memory disc of claim 2 wherein the laser light source, the light transmission module and the light receiving module are all disposed on a pick-up head assembly supported for movement radially with respect to the optical disc.

11. A read system for an optical memory disc, comprising:
a pick-up head supported for radial movement relative to a rotatable optical disc;
a laser diode supported on the pick-up head and operative to generate an output beam;
a light path handling module adapted to receive the light beam from the laser diode and perform wavelength purification and light beam splitting to divide transmitted and received beams;
an objective lens module supported to receive the light beam from the light path handling module, the objective lens module comprising a fixed focus convex lens and a liquid crystal lens, the liquid crystal lens comprising a liquid crystal module supported between a pair of planar indium-tin oxide electrodes; and
a light receiving module connected to receive the light beam reflected from the disc back through the objective lens module and the light path handling module and to provide it to an error tracking module which detects errors in tracking and focus and generates electrical signals which are applied to the two indium-tin oxide electrodes to correct the focusing error and tracking errors.
